(19) United States
(12) Patent Application Publication
(10) Pub. No.: US 2010/0219651 A1
(43) Pub. Date: Sep. 2, 2010

(54) VACUUM LIFTING DEVICE AND METHOD OF USE

(75) Inventors: Herbert E. Walter, Eureka, MO (US); Cheryl Ann Walters, Eureka, MO (US); Timothy Michael Elfrink, Maplewood, MO (US)

Correspondence Address: THE SMALL PATENT LAW GROUP LLP, 225 S. MERAMEC, STE. 725T, ST. LOUIS, MO, 63105, US

(73) Assignee: CUSTOM CONCRETE CREATIONS, High Ridge, MO (US)

(21) Appl. No.: 12/713,658

(22) Filed: Feb. 26, 2010

Related U.S. Application Data
(60) Provisional application No. 61/156,290, filed on Feb. 27, 2009.

(51) Int. Cl. B66C 1/02; B23P 11/00

(52) U.S. Cl. 294/64.1; 29/428

(57) ABSTRACT

A vacuum lifting device and method of manufacture thereof includes a vacuum generator for generating a vacuum. The vacuum lifting device also includes a base having opposite first and second sides and a vacuum lifting chamber provided on the second side of the base and having a suction end. The vacuum lifting chamber is in fluid communication with the vacuum generator, wherein the vacuum generator creates negative pressure within the vacuum lifting chamber. A gasket is coupled to the suction end of the vacuum lifting chamber and is configured to create a vacuum seal with a surface of an object to be lifted by the vacuum lifting device.

### BACKGROUND OF THE INVENTION

The subject matter herein relates generally to vacuum lifting devices, and more particularly to lifting devices and methods for lifting heavy planar objects such as concrete pavers.

Problems arise when trying to lift heavy objects. For example, concrete and brick pavers are in wide use in landscaping and in particular, in hardscapes. The pavers have a range of sizes. Larger pavers have the advantage of covering more square feet by placing the individual paver, thus reducing the time it takes to cover the hardscape. However, larger pavers have the disadvantage of increased weight. Typically, a paver having a size of approximately one square foot is manageable for an installer to handle. Pavers that are larger are difficult to move and place without the aid of machines or carts or other people to help move the paver. Some pavers are so large that a machine, such as a tractor, is required to move the paver. However, such pavers are susceptible to damage when being moved by the bucket or forks of the machine. Other types of objects are also difficult to move, even when using machines.

Furthermore, a known problem exists when sidewalk slabs of concrete are heaved out of place, such as by roots or freeze/thaw cycles. Typically, when this problem is encountered, the solution is to break out the concrete and pour a new slab. Such solution is costly and may have other undesirable effects, such as discoloration between the new slab and the old slabs.

Some known devices have been developed that are used to lift planar objects using a vacuum. However, such devices are inadequate for lifting objects that have a rough surface. Rather, such devices are useful for lifting objects having a smooth surface so that a proper seal can be created on the surface.

Accordingly, a need exists for a device that is capable of moving large pavers. A need exists for a device that is capable of moving large pavers without damaging the pavers. A need exists for a device capable of moving objects having rough surfaces.

### BRIEF DESCRIPTION OF THE INVENTION

In one embodiment, a vacuum lifting device is provided that includes a vacuum generator for generating a vacuum. The vacuum lifting device also includes a base having opposite first and second sides and a vacuum lifting chamber provided on the second side of the base and having a suction end. The vacuum lifting chamber is in fluid communication with the vacuum generator, wherein the vacuum generator creates negative pressure within the vacuum lifting chamber. A gasket is coupled to the suction end of the vacuum lifting chamber and is configured to create a vacuum seal with a surface of an object to be lifted by the vacuum lifting device.

Optionally, the vacuum lifting device may include a vacuum reservoir separate from a vacuum lifting chamber, where the vacuum reservoir is in fluid communication with the vacuum generator to create a negative pressure within the vacuum reservoir. The vacuum reservoir may be connected to the vacuum lifting chamber by a conduit, wherein airflow between the vacuum reservoir and the vacuum lifting chamber is controlled through the conduit. A valve may be coupled to, and may control a flow within, the conduit. Negative pressure created in the vacuum reservoir may surge into the vacuum lifting chamber when the valve is opened to create negative pressure within the vacuum lifting chamber. Optionally, the volume of the vacuum lifting chamber may be smaller than the volume of the vacuum reservoir such that the pressure within the vacuum lifting chamber may be quickly reduced to create a vacuum within the vacuum lifting chamber.

Optionally, the suction end may include a hollow gasket pipe surrounding a perimeter thereof with the gasket being attached to the gasket pipe. The gasket pipe may have at least one opening therein thereby creating a vacuum within the hollow gasket pipe. The gasket pipe may have at least one vacuum slot in fluid communication with the vacuum lifting chamber thereby creating a vacuum within the hollow gasket pipe and at least one vacuum hole at an interface between the gasket pipe and the gasket such that the vacuum within the hollow gasket pipe draws the gasket against the gasket pipe.

Optionally, the vacuum lifting device may include a release mechanism configured to change the pressure within the vacuum lifting chamber to release the object from the suction end. A handle may be provided extending from the first side of the base for maneuvering the vacuum lifting device. At least one lift point may be provided being configured to the lifted by a machine capable of lifting the vacuum lifting device and the object. The lift point may be approximately centered along a center of gravity of the vacuum lifting device.

In another embodiment, a vacuum lifting device is provided that includes a vacuum generator for generating a vacuum. The vacuum lifting device also includes a base having opposite first and second sides and a vacuum lifting chamber is provided on the second side of the base having a suction end configured to create a vacuum seal with a surface of an object to be lifted by the vacuum lifting device. A vacuum reservoir is separate from the vacuum lifting chamber. The vacuum reservoir is in fluid communication with the vacuum generator to create a negative pressure within the vacuum reservoir. The vacuum reservoir is connected to the vacuum lifting chamber by a conduit, wherein airflow between the vacuum reservoir and the vacuum lifting chamber is controlled through the conduit.

In a further embodiment, a method of lifting objects is providing including the steps of positioning of vacuum lifting device on a surface of the object, the vacuum lifting device having vacuum generator and a vacuum lifting chamber being in fluid communication with the vacuum generator and a gasket coupled to a suction end of the vacuum lifting chamber. The method also including operating the vacuum generator to create a negative pressure within the vacuum lifting chamber such that the gasket creates a vacuum seal with the surface of the object to be lifted by the vacuum lifting device. The method also includes lifting the vacuum lifting device and corresponding vacuum suctioned object using a machine capable of lifting the vacuum lifting device and the object and maneuvering the object to a desired location and releasing the object from the suction end of the vacuum of the chamber.

In another embodiment, a method of manufacturing a vacuum lifting device is provided including providing a vacuum lifting chamber having a suction end configured to be set on an object to be lifted and providing a vacuum reservoir. The method also includes providing a vacuum generator in fluid communication with the vacuum reservoir, the vacuum generator being configured to create a vacuum in the vacuum reservoir. The method also includes coupling a conduit between the vacuum lifting chamber and the vacuum reservoir and coupling a valve to the conduit, the valve controlling airflow between the vacuum lifting chamber and the vacuum reservoir.

### BRIEF DESCRIPTION OF THE DRAWINGS

FIG. 1 illustrates a vacuum lifting device formed in accordance with an exemplary embodiment.

FIG. 2 is a schematic illustration of the vacuum lifting device.

FIG. 3 is a front perspective view of the vacuum lifting device.

FIG. 4 is a side perspective view of the vacuum lifting device.

FIG. 5 is a bottom view of a gasket pipe for the vacuum lifting device.

FIG. 6 is a cross-sectional view of the gasket pipe shown in FIG. 5.

FIG. 7 is a front perspective view of an alternative vacuum lifting device formed in accordance with an alternative embodiment.

FIG. 8 is a front perspective view of another alternative vacuum lifting device formed in accordance with another alternative embodiment.

FIG. 9 is a flow chart of an exemplary method of operating a vacuum lifting device.

FIG. 10 is a flow chart of an exemplary method of manufacturing a vacuum lifting device.

### DETAILED DESCRIPTION OF THE INVENTION

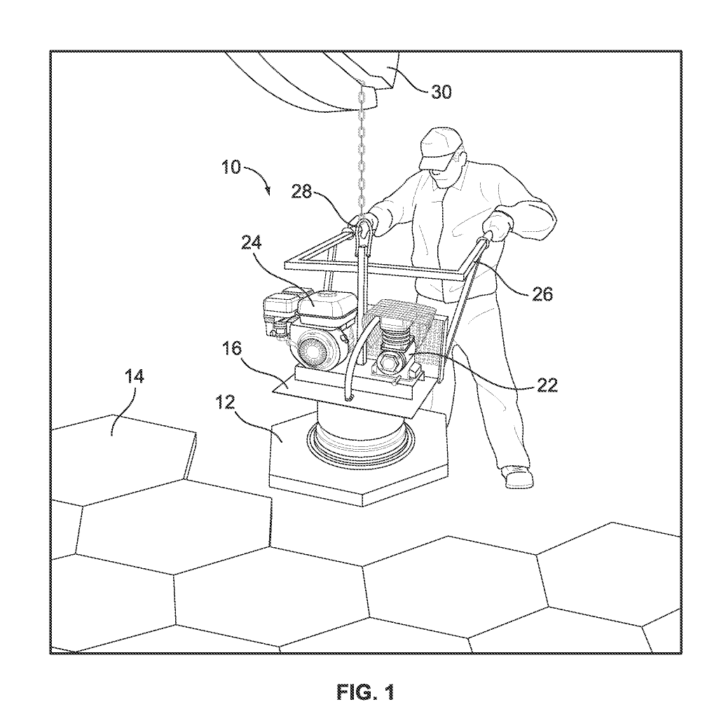

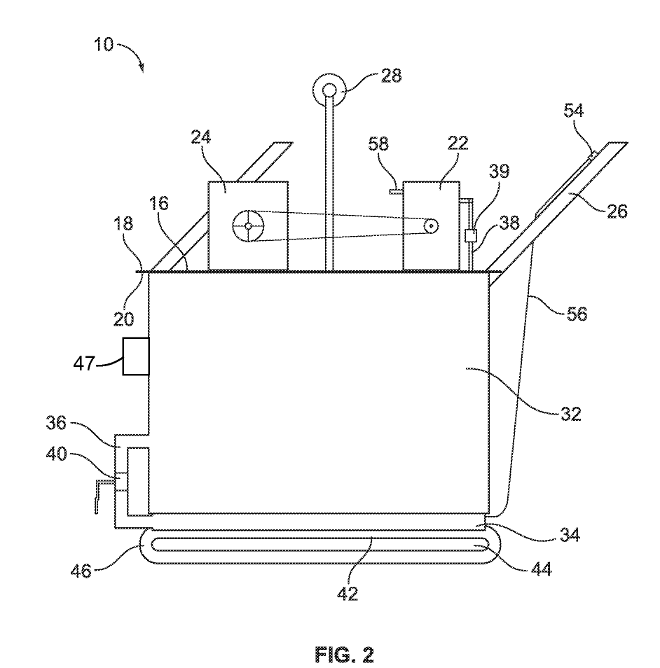

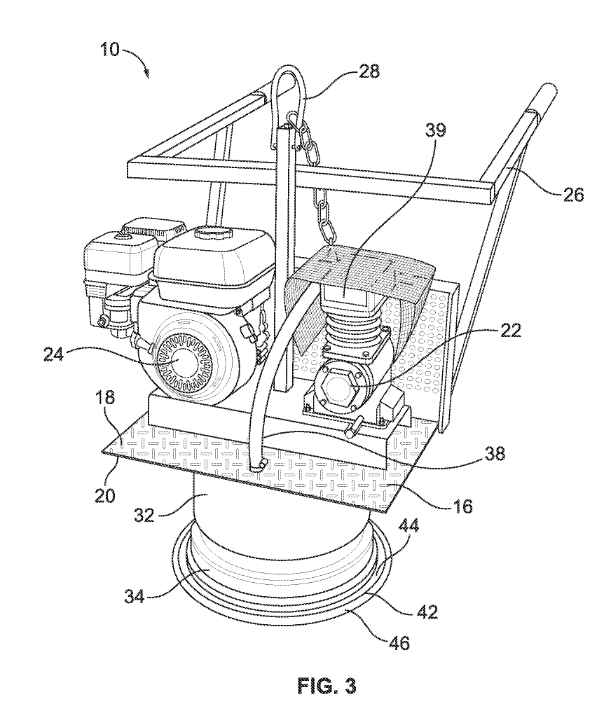

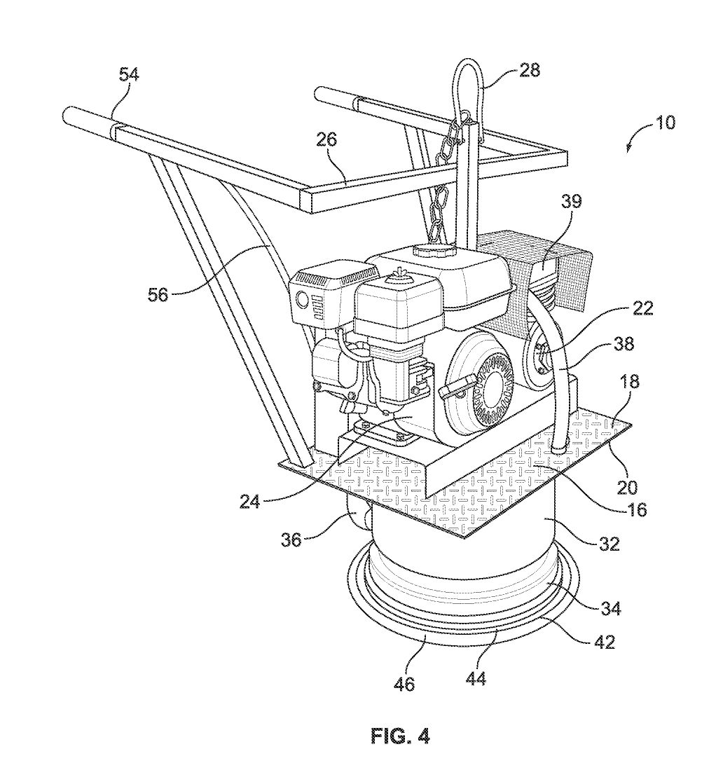

FIG. 1 illustrates a vacuum lifting device 10 formed in accordance with an exemplary embodiment. FIG. 2 is a schematic illustration of the vacuum lifting device 10 and FIGS. 3 and 4 are front and side perspective views, respectively, of the vacuum lifting device 10. The vacuum lifting device 10 is operated to lift objects 12, such as concrete or brick pavers, concrete slabs (e.g. sidewalk slabs), steel plates (e.g. trench covers), and the like.

The vacuum lifting device 10 facilitates lifting heavy objects that are difficult or impossible to lift by hand. The vacuum lifting device 10 may be operated in a manner that minimizes damage, or the risk of damage to the objects 12. The vacuum lifting device 10 may be operated with minimal exertion by the person installing the objects 12 and without the need for many people lifting and positioning the objects 12. The vacuum lifting device 10 may be configured to lift planar objects having either rough or smooth surfaces. For example, the vacuum lifting device 10 may be capable of lifting concrete objects that have rough surfaces or steel objects that have smooth surfaces. Additionally, while the objects 12 are illustrated as having a planar lifting surface 14, it is realized that the vacuum lifting device 10 may be used to lift objects that have nonplanar lifting surfaces.

One exemplary application for the vacuum lifting device 10 is lifting and placing concrete or brick pavers, such as during construction of a patio, sidewalk, driveway, garden, and the like. Another exemplary application for the vacuum lifting device 10 is lifting and placing existing sidewalk concrete slabs, such as to repair uneven sidewalk slabs. For example, when sidewalk slabs are heaved out of place by tree roots or other causes, the vacuum lifting device 10 may be operated to lift the sidewalk slab out of place, relevel the subsurface below the sidewalk, and then replace the sidewalk slab. As a result, the sidewalk slab is reusable, and may be replaced without having to repour a new sidewalk slab, which may be costly and may not have a matching color, which is undesirable. Another exemplary application for the vacuum lifting device 10 is lifting and placing steel trench covers during road construction or repair, which are very heavy and awkward to lift. The vacuum lifting device 10 has many other applications as well, including industrial applications.

The vacuum lifting device 10 includes a base 16 having opposed first and second sides 18, 20. The first side 18 generally defines an upper side and the second side generally defines a bottom side. A vacuum generator 22 is mounted to the first side 18 of the base 16. The vacuum generator 22 is configured to generate a vacuum. Optionally, the vacuum generator 22 may constitute a vacuum pump. Alternatively, the vacuum generator 22 may constitute an air compressor, or another device that creates a vacuum. The vacuum generator 22 may include a motor 24 or other power generation source for operating the vacuum generator 22. The motor 24 is also mounted to the first side 18 of the base 16. The motor 24 may be operated to directly drive the vacuum generator 22. Alternatively, the motor 24 may be operated to supply power to the vacuum generator 22, which includes a separate driver for operating the vacuum generator 22. In an alternative embodiment, the motor 24 (or other power source) may be remote from the vacuum generator 22 and connected thereto, such as by a power conduit.

A handle 26 extends from the first side 18 of the base 16. The handle 26 may be grabbed or held by the operator for maneuvering the vacuum lifting device 10. In an exemplary embodiment, the handle 26 includes one or more lift point(s) 28 from which a machine or piece of equipment 30 can attach and lift the vacuum lifting device 10 and object 12 suctioned to the vacuum lifting device 10. The equipment 30 may be a piece of construction equipment such as a crane, tractor, bobcat, track hoe, and the like capable of lifting the weight of the vacuum lifting device 10 and object 12. For example, the equipment 30 may include a hydraulically operated arm or bucket capable of being lifted up and down and/or being moved around the site to position the object 12. In the illustrated embodiment, the lift point 28 is represented by an eyelet, and a chain is connected between the eyelet and the equipment 30. In an exemplary embodiment, the lift point 28 may be substantially centered along the center of gravity of the vacuum lifting device 10. In an alternative embodiment, multiple lift points 28 are provided, such as on opposite sides of the vacuum lifting device 10 or spaced evenly apart along an outer perimeter of the vacuum lifting device 10. Optionally, one or more safety straps may be coupled to the vacuum lifting device 10, such as to the handle 26 and/or to the base 16 that are used to help secure the object 12 in place with respect to the vacuum lifting device 10.

The vacuum lifting device 10 includes a vacuum reservoir 32 and a vacuum lifting chamber 34 that are in fluid communication with the vacuum generator 22 and one another. In an exemplary embodiment, the vacuum reservoir 32 and the vacuum lifting chamber 34 are both provided on the second side 20 of the base 16. For example, the vacuum reservoir 32 may be provided directly below the second side of the base 16, and the vacuum lifting chamber 34 may be provided below the vacuum reservoir 32. The vacuum lifting chamber 34 may be provided at a bottom of the vacuum lifting device 10. The vacuum reservoir 32 and the vacuum lifting chamber 34 are separate from one other. For example, a plate or other component may be provided between the vacuum reservoir 32 and the vacuum lifting chamber 34, where the vacuum lifting chamber 34 and/or the vacuum reservoir 32 are welded to the plate in an airtight manner.

The vacuum lifting chamber 34 and the vacuum reservoir 32 are connected to one another by a conduit 36 (shown in FIGS. 2 and 4). The conduit 36 may be a hose, tube or pipe, such as in the illustrated embodiment, or alternatively, the conduit 36 may be an opening in a plate or other structure separating the vacuum lifting chamber 34 and the vacuum reservoir 32. The flow of air between the vacuum lifting chamber 34 and the vacuum reservoir 32 may be controlled, such as by a valve or other device that controls airflow through the conduit 36.

During operation, the vacuum generator 22 is operated to create a negative pressure within the vacuum reservoir 32. Optionally, a conduit 38 extends between the vacuum generator 22 and the vacuum reservoir 32. Air is sucked out of the vacuum reservoir 32 through the conduit 38 to create a negative pressure within the vacuum reservoir 32. Optionally, an air filter 39 may be associated with the conduit 38 to prevent dirt or debris from damaging the vacuum generator 22.

In an exemplary embodiment, a control valve 40 (shown in FIG. 2) is coupled to the conduit 36 and controls the flow of air between the vacuum lifting chamber 34 and the vacuum reservoir 32. During operation, the control valve 40 may be closed until a vacuum having a predetermined negative pressure is created within the vacuum reservoir 32. Once the vacuum lifting device 10 is positioned on the object 12, the control valve 40 may be opened and the air within the vacuum lifting chamber 34 may be quickly expelled from the vacuum lifting chamber 34 into the vacuum reservoir 32 to create a vacuum within the vacuum lifting chamber 34. This surge of vacuum into the vacuum lifting chamber 34 creates a fast seal with the object 12.

The relative sizes of the vacuum lifting chamber 34 and the vacuum reservoir 32 may be selected such that the air within the vacuum lifting chamber 34 may be quickly expelled. For example, a volume of the vacuum reservoir 32 may be substantially larger than a volume of the vacuum lifting chambers 34. In the illustrated embodiment, the volume of the vacuum reservoir 32 is approximately four times the volume of the vacuum lifting chambers 34. The volume of the vacuum reservoir 32 may be sufficient enough to maintain a constant supply of vacuum for the vacuum lifting chamber 34. The volume of the vacuum lifting chamber 34 can be relatively small, where the smaller the vacuum lifting chamber 34 the less reserved vacuum will be used from the vacuum reservoir 32. Also, the vacuum surge into the vacuum lifting chamber 34 is quicker the smaller the volume of the vacuum lifting chamber 34. The motor 24 and vacuum generator 22 may run at all times of operation giving a constant supply of vacuum in order to get continuous lifting from one object 12 to the next. Because the vacuum reservoir 32 has a constant supply of vacuum, the vacuum lifting device 10 may be set in place and is ready for use. There is no waiting for a vacuum to build up in the vacuum lifting chamber 34, as the vacuum surge from the vacuum reservoir 32 is very quick when the control valve 40 is operated. For example, when the control valve 40 is in a closed state, the vacuum is built up on the vacuum reservoir 32, and no vacuum is created in the vacuum lifting chamber 34. When the control valve 40 is in an open state, the vacuum lifting chamber 34 and the vacuum reservoir 32 are in fluid communication with one another and the air in the vacuum lifting chamber 34 is sucked out of the vacuum lifting chamber 34 through the conduit 36, thus creating a vacuum in the vacuum lifting chamber 34.

The vacuum lifting chamber 34 has a suction end 42 at a bottom thereof generally opposite the base 16. The suction end 42 rests on the object 12. A hollow gasket pipe 44 is provided at the suction end 42. The gasket pipe 44 is generally tubular in cross-section and is shaped to fit around the perimeter of the suction end 42. In the illustrated embodiment, the gasket pipe 44 is ring-shaped, however the gasket pipe 44 may have other shapes in alternative embodiments depending on the shape of the perimeter of the vacuum lifting chamber 34. A gasket 46 is coupled to the gasket pipe 44 at the suction end 42. The gasket 46 is configured to create a vacuum seal with a surface of the object 12 to be lifted by the vacuum lifting device 10.

In an exemplary embodiment, the vacuum lifting device 10 includes at least one safety device 47 (shown in FIG. 2). In the illustrated embodiment, the safety device 47 constitutes a pressure sensor having an indicator for the operator to indicate when a pressure in the vacuum lifting chamber 34 and/or the vacuum reservoir 32 are at a predetermined level. For example, when the pressure in the vacuum lifting chamber 34 and/or the vacuum reservoir 32 falls below a predetermined amount, an audible alarm will sound notifying the operator of the low pressure condition. Other types of sensors and/or alarms may be used with the vacuum lifting device 10.

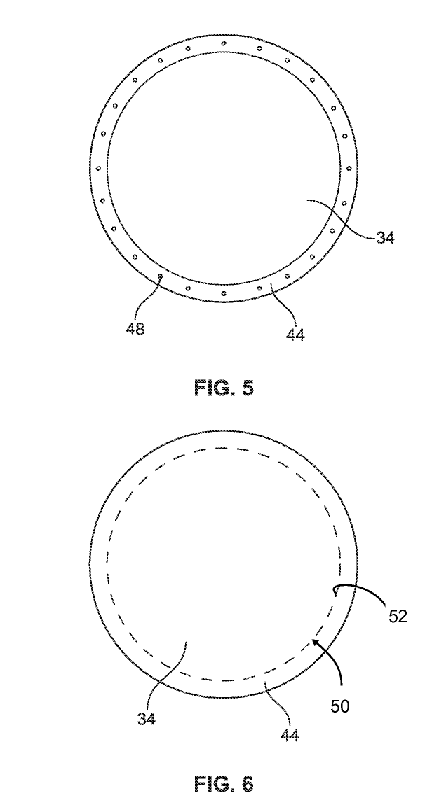

FIGS. 5 and 6 are bottom and cross-sectional views, respectively, of the gasket pipe 44. The gasket pipe 44 includes a plurality of openings therein. For example, FIG. 5 illustrates a plurality of vacuum holes 48 formed in the bottom of the gasket pipe 44. FIG. 6 illustrates a plurality of vacuum slots 50 formed in an inner side 52 of the gasket pipe 44. The vacuum slots 50 are in fluid communication with the vacuum lifting chamber 34 and create a suction within the hollow gasket pipe 44 to hold the gasket 46 on the gasket pipe 44. For example, when there is a vacuum in the vacuum lifting chamber 34, air is drawn through the vacuum slots 50 and the vacuum holes 48 to hold the gasket 46 on the gasket pipe 44.

Returning to FIGS. 1-4, the gasket 46 is manufactured from a soft or pliable material such as a plastic material, a rubber material, a foam material, and the like. The material of the gasket 46 is configured to create a seal with the planar surface 14 of the object 12. Even though the planar surface 14 of the object 12 may be rough, the gasket 46 seals against the object 12 without a significant loss of vacuum. The gasket 46 may include a split or seam to fit the gasket 46 around the gasket pipe 44. The gasket 46 may conform to the rough surface to create an adequate seal with the object 12. In an exemplary embodiment, the gasket 46 may allow sealing to a surface having variations in the surface of between approximately ½ inch to ¾ inch or more.

FIG. 2 illustrates a release mechanism 54 that may be activated by the installer to release the vacuum in the vacuum lifting chamber 34. In an exemplary embodiment, the release mechanism 54 may be a mechanical device, such as a valve, that allows air to flow through a tube 56 connecting the release mechanism 54 and the vacuum lifting chamber 34. Alternatively, the release mechanism 54 may be an electrical device, such as a switch that is operatively coupled to a separate mechanical device or to the vacuum generator 22, to change the pressure in the vacuum lifting chamber 34 to reduce the amount of suction, which releases the vacuum lifting device 10 from the object 12. Optionally, an air outlet 58 of the vacuum generator 22 may have a tube (not shown) coupled thereto that is also coupled to the vacuum lifting chamber 34. When the release mechanism 54 is actuated, the air in the tube may flow into the vacuum lifting chamber 34, filling it with air, and thus illuminating the vacuum within the vacuum lifting chamber 34.

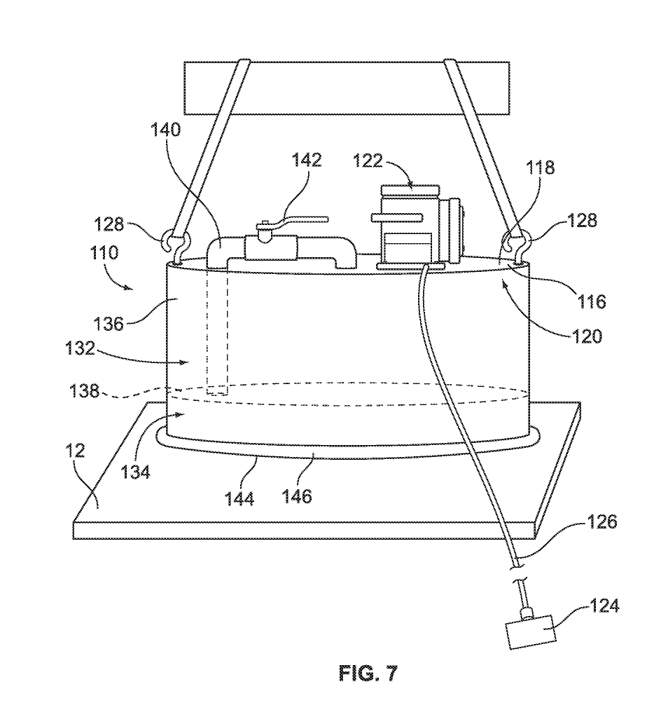

FIG. 7 is a front perspective view of an alternative vacuum lifting device 110 formed in accordance with an alternative embodiment. The vacuum lifting device 110 may be similar to the vacuum lifting device 10 (shown in FIGS. 1-4) and include similar features for operation.

The vacuum lifting device 110 includes a base 116 having opposed first and second sides 118, 120. A vacuum generator 122 is mounted to the first side 118 of the base 116. A power source 124 is remote from the vacuum generator 122, and is electrically connected to the vacuum generator 122 by a power cable 126. Optionally, the power source 124 may be a power outlet, such as a 110V power outlet and the power cable 126 may be an extension cord. The vacuum lifting device 110 includes two lift points 128 on opposite sides of the base 116. Straps, chains or other items may be coupled to the lift points 128 for connecting to the machine adapted for lifting the vacuum lifting device 110.

The vacuum lifting device 110 includes a vacuum reservoir 132 and a vacuum lifting chamber 134 in fluid communication with one another and the vacuum generator 122. In an exemplary embodiment, the vacuum reservoir 132 and the vacuum lifting chamber 134 are defined by a body 136 surrounding an outer perimeter of the vacuum reservoir 132 and the vacuum lifting chamber 134. A plate 138 (shown in phantom) is coupled to the body 134, such as by welding, to separate the vacuum reservoir 132 from the vacuum lifting chamber 134. A conduit 140 is open to the vacuum reservoir 132 and to the vacuum lifting chamber 134. In the illustrated embodiment, the conduit 140 constitutes a pipe. A portion of the conduit 140 is positioned above the base 116 and includes a valve 142 for controlling airflow through the conduit 140. The conduit 140 extends through the plate 138 to open to the vacuum lifting chamber 134. A portion (shown in phantom) of the conduit 140 is routed through the vacuum chamber 132 between the base 116 and the plate 138. As such, a portion of the conduit 140 is internal to the vacuum reservoir 132. In an alternative embodiment, the conduit 140 is routed only on the outside of the vacuum reservoir 132, such as along a side of the body 136.

The valve 142 is accessible to the operator. In operation, once an adequate vacuum is created in the vacuum reservoir 132, the operator opens the valve 142 to create a vacuum surge into the vacuum lifting chamber 134. The surge creates a seal at a suction end 144 of the vacuum lifting device 110 with the object 12, which in the illustrated embodiment is represented by a concrete slab, however other types of objects may be lifted in alternative embodiments. In an exemplary embodiment, a gasket 146 is provided at the suction end 144 for sealing with the object 12 when a vacuum is created in the vacuum lifting chamber 134.

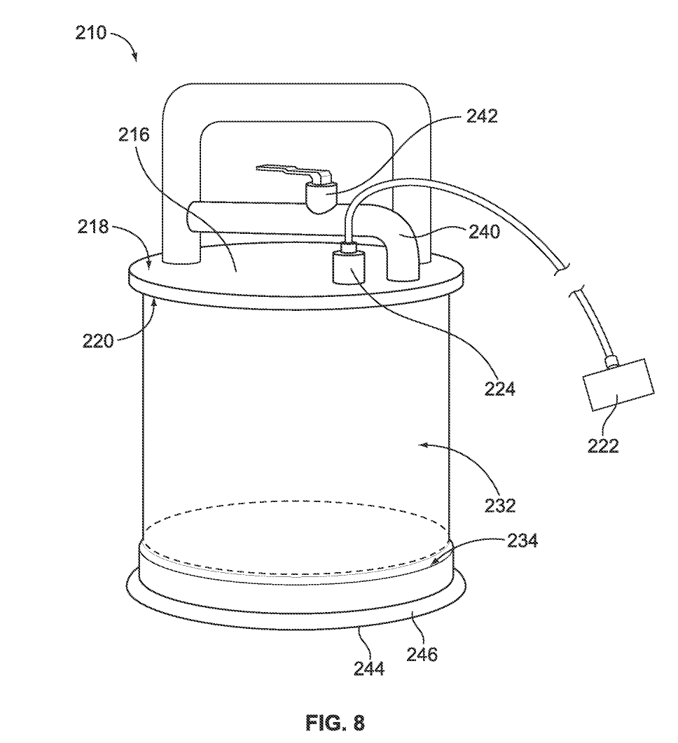

FIG. 8 is a front perspective view of another alternative vacuum lifting device 210 formed in accordance with another alternative embodiment. The vacuum lifting device 210 may be similar to the vacuum lifting device 10 (shown in FIGS. 1-4) and include similar features for operation.

The vacuum lifting device 210 includes a base 216 having opposed first and second sides 218, 220. A vacuum generator 222 is provided and is positioned remote from the vacuum lifting device 210. A port 224 is provided on the vacuum lifting device 210, such as at the base 216 for connection to the vacuum generator 222. For example, a hose or pipe may be connected to the port 224 to attach the vacuum generator 222 to the vacuum lifting device 210. Optionally, the port 224 may be provided with a quick connect/disconnect type of fitting for connection of the hose.

The vacuum lifting device 210 includes a vacuum reservoir 232 and a vacuum lifting chamber 234 in fluid communication with one another and the vacuum generator 222. A conduit 240 connects the vacuum reservoir 232 and the vacuum lifting chamber 234. The conduit 240 includes a valve 242 for controlling airflow through the conduit 240. The valve 242 is accessible to the operator. In operation, once an adequate vacuum is created in the vacuum reservoir 232, the operator opens the valve 242 to create a vacuum surge into the vacuum lifting chamber 234. The surge creates a seal at a suction end 244 of the vacuum lifting device 210 with the object 12. In an exemplary embodiment, a gasket 246 is provided at the suction end 244 for sealing with the object 12 when a vacuum is created in the vacuum lifting chamber 234.

In an alternative embodiment, rather than a separate conduit connecting the chambers, a valve may be provided at the port 224 for controlling the vacuum supply to the chambers. Optionally, only a single chamber may be provided. For example, the vacuum lifting device 210 may only include the vacuum lifting chamber 234, and not the vacuum reservoir 232. The valve at the port 224 controls the vacuum supply to the vacuum lifting chamber 234. When the valve is open, a vacuum is created in the vacuum lifting chamber 234. When the valve is closed, the vacuum supply is shut off from the vacuum lifting chamber 234. Optionally, the valve and/or the port 224 may include a bleed hole in fluid communication with the vacuum lifting chamber 234 when the valve is in the closed position. As such, when the valve is closed, air is allowed to fill the vacuum lifting chamber 234, thus releasing the suction with the object 12.

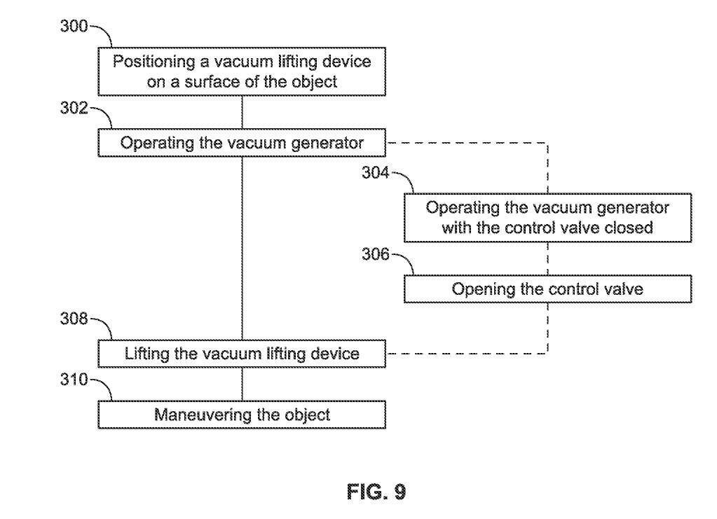

FIG. 9 is a flow chart of an exemplary method of operating the vacuum lifting device for lifting objects. The method includes positioning 300 a vacuum lifting device on a surface of the object. In an exemplary embodiment, the vacuum lifting device includes vacuum generator for generating a vacuum and a body defining a vacuum reservoir and a vacuum lifting chamber, which are both in fluid communication with the vacuum generator. The vacuum reservoir is separate from the vacuum lifting chamber and is connected to the vacuum lifting chamber by a conduit having a control valve. A gasket is optionally coupled to a suction end of the vacuum lifting chamber.

The method also includes operating 302 the vacuum generator to create a negative pressure within the vacuum lifting chamber such that the gasket creates a vacuum seal with the surface of the object to be lifted by the vacuum lifting device. Optionally, the vacuum generator may be continuously operated such that the vacuum reservoir is always under negative pressure, and thus always has a vacuum therein. The method may optionally include the steps of operating 304 the vacuum generator with the control valve closed to create a negative pressure within the vacuum reservoir and then opening 306 the control valve to create a negative pressure within the vacuum lifting chamber. As such, the presence of a vacuum in the vacuum lifting chamber is controllable, whereas the vacuum in the vacuum reservoir is constant or continuous. Optionally, a vacuum reservoir having a volume that is substantially greater than a volume of the vacuum lifting chamber may be utilized such that a negative pressure can be created within the vacuum lifting chamber quickly upon opening 306 the control valve.

The method also includes lifting 308 the vacuum lifting device and corresponding vacuum suctioned object using a machine capable of lifting the vacuum lifting device and the object. For example, a tractor or other large piece of machinery may be employed to move the device and the object. The method also includes maneuvering 310 the object to a desired location and releasing the object from the suction end of the vacuum of the chamber. For example, a release valve may be provided that may be actuated to release the vacuum pressure in the vacuum lifting chamber.

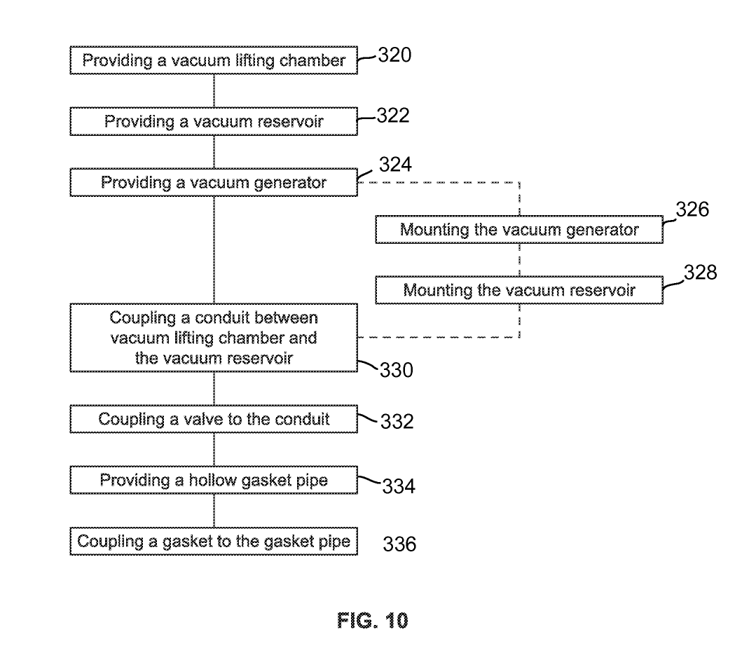

FIG. 10 is a flow chart of an exemplary method of manufacture of a vacuum lifting device for lifting objects. The method includes providing 320 a vacuum lifting chamber having a suction end configured to be set on an object to be lifted and providing 322 a vacuum reservoir. Optionally, the vacuum reservoir and vacuum lifting chamber may be formed from a common body and separated by a plate or other separating structure. Alternatively, the vacuum reservoir and vacuum lifting chamber may be formed separate from one another and coupled to one another to form a unitary body. In another alternative embodiment, the vacuum reservoir and vacuum lifting chamber may be separate from one another and may remain physically separate from one another during operation of the vacuum lifting device.

The method also includes providing 324 a vacuum generator in fluid communication with the vacuum reservoir and the vacuum lifting chamber. The vacuum generator is configured to create a vacuum in the vacuum reservoir when operated. The vacuum generator may be mounted to a common base with the vacuum reservoir. For example, the method may optionally include the steps of mounting 326 the vacuum generator to one side of a base and mounting 328 the vacuum reservoir to another side of the base. In an alternative embodiment, the vacuum generator may remain separate from the vacuum reservoir during operation, but may be coupled to the vacuum reservoir by a hose, pipe or other type of conduit to create a vacuum in the vacuum reservoir.

The method further includes the steps of coupling 330 a conduit between the vacuum lifting chamber and the vacuum reservoir and coupling 332 a valve to the conduit. The valve controls airflow between the vacuum lifting chamber and the vacuum reservoir. When the valve is closed, a negative pressure is created within the vacuum reservoir but not in the vacuum lifting chamber. When the valve is open, a negative pressure is created in the vacuum lifting chamber. As such, the presence of a vacuum in the vacuum lifting chamber is controllable, whereas the vacuum in the vacuum reservoir is constant or continuous.

The method may also include the steps of providing 334 a hollow gasket pipe at the suction end and coupling 336 a gasket to the gasket pipe. The hollow gasket pipe may have at least one opening therethrough such that a vacuum is configured to be created in the gasket pipe. The gasket may be suctioned to the gasket pipe by the vacuum created in the gasket pipe when a vacuum is created in the gasket pipe.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. A vacuum lifting device comprising:
a vacuum generator for generating a vacuum;
a base having opposite first and second sides;
a vacuum lifting chamber provided on the second side of the base, the vacuum lifting chamber having a suction end, the vacuum lifting chamber being in fluid communication with the vacuum generator, wherein the vacuum generator creates negative pressure within the vacuum lifting chamber, and
a gasket coupled to the suction end of the vacuum lifting chamber, the gasket being configured to create a vacuum seal with a surface of an object to be lifted by the vacuum lifting device.

2. The vacuum lifting device of claim 1, further comprising a vacuum reservoir separate from a vacuum lifting chamber, the vacuum reservoir being in fluid communication with the vacuum generator to create a negative pressure within the vacuum reservoir, the vacuum reservoir being connected to the vacuum lifting chamber by a conduit, wherein airflow between the vacuum reservoir and the vacuum lifting chamber is controlled through the conduit.

3. The vacuum lifting device of claim 2, further comprising a valve coupled to, and controlling a flow within, the conduit, wherein negative pressure created in the vacuum reservoir surges into the vacuum lifting chamber when the valve is opened to create negative pressure within the vacuum lifting chamber.

4. The vacuum lifting device of claim 2, wherein the volume of the vacuum lifting chamber is smaller than the volume of the vacuum reservoir such that the pressure within the vacuum lifting chamber may be quickly reduced to create a vacuum within the vacuum lifting chamber.

5. The vacuum lifting device of claim 1, wherein the suction end includes a hollow gasket pipe surrounding a perimeter thereof, the gasket being attached to the gasket pipe, the gasket pipe having at least one opening therein thereby creating a vacuum within the hollow gasket pipe.

6. The vacuum lifting device of claim 1, wherein the suction end includes a hollow gasket pipe surrounding a perimeter thereof, the gasket being attached to the gasket pipe, the gasket pipe having at least one vacuum slot in fluid communication with the vacuum lifting chamber thereby creating a vacuum within the hollow gasket pipe, the gasket pipe having at least one vacuum hole at an interface between the gasket pipe and the gasket such that the vacuum within the hollow gasket pipe draws the gasket against the gasket pipe.

7. The vacuum lifting device of claim 1, further comprising a release mechanism configured to change the pressure within the vacuum lifting chamber to release the object from the suction end.

8. The vacuum lifting device of claim 1, further comprising a handle extending from the first side of the base for maneuvering the vacuum lifting device.

9. The vacuum lifting device of claim 1, further comprising at least one lift point configured to the lifted by a machine capable of lifting the vacuum lifting device and the object.

10. The vacuum lifting device of claim 1, further comprising a lift point that is approximately centered along a center of gravity of the vacuum lifting device.

11. The vacuum lifting device of claim 1, wherein the vacuum generator is mounted to the first side of the base.

12. The vacuum lifting device of claim 1, wherein the vacuum generator is positioned remote from the base and the vacuum lifting chamber and connected thereto by a conduit.

13. The vacuum lifting device of claim 1, wherein a surface area of the suction end is selected based on the weight of the object to be lifted by the vacuum lifting device.

14. The vacuum lifting device of claim 1, further comprising a safety device configured to notify the operator of a low pressure condition.

15. A vacuum lifting device comprising:
a vacuum generator for generating a vacuum;
a base having opposite first and second sides;
a vacuum lifting chamber provided on the second side of the base, the vacuum lifting chamber having a suction end configured to create a vacuum seal with a surface of an object to be lifted by the vacuum lifting device; and
a vacuum reservoir separate from the vacuum lifting chamber, the vacuum reservoir being in fluid communication with the vacuum generator to create a negative pressure within the vacuum reservoir, the vacuum reservoir being connected to the vacuum lifting chamber by a conduit, wherein airflow between the vacuum reservoir and the vacuum lifting chamber is controlled through the conduit.

16. The vacuum lifting device of claim 15, further comprising a valve coupled to, and controlling a flow within, the conduit, wherein negative pressure created in the vacuum reservoir surges into the vacuum lifting chamber when the valve is opened to create negative pressure within the vacuum lifting chamber.

17. The vacuum lifting device of claim 15, wherein a volume of the vacuum lifting chamber is smaller than a volume of the vacuum reservoir such that a pressure within the vacuum lifting chamber may be quickly reduced to create a vacuum within the vacuum lifting chamber.

18. The vacuum lifting device of claim 15, further comprising a gasket at the suction end, the gasket creating a seal with the object.

19. The vacuum lifting device of claim 15, further comprising a release mechanism configured to change the pressure within the vacuum lifting chamber to release the object from the suction end.

20. The vacuum lifting device of claim 15, wherein the vacuum generator is mounted to the first side of the base.

21. The vacuum lifting device of claim 15, wherein the vacuum generator is positioned remote from the base and the vacuum lifting chamber and connected thereto by a conduit.

22. A method of manufacturing a vacuum lifting device comprising:
providing a vacuum lifting chamber having a suction end configured to be set on an object to be lifted;
providing a vacuum reservoir;
providing a vacuum generator in fluid communication with the vacuum reservoir, the vacuum generator being configured to create a vacuum in the vacuum reservoir;
coupling a conduit between the vacuum lifting chamber and the vacuum reservoir; and
coupling a valve to the conduit, the valve controlling airflow between the vacuum lifting chamber and the vacuum reservoir.

23. The method of claim 22, further comprising mounting the vacuum generator to one side of a base and mounting the vacuum reservoir to another side of the base.

24. The method of claim 22, further comprising:
providing a hollow gasket pipe at the suction end, the hollow gasket pipe having at least one opening therethrough such that a vacuum is configured to be created in the gasket pipe; and
coupling a gasket to the gasket pipe, the gasket being suctioned to the gasket pipe by the vacuum created in the gasket pipe when a vacuum is created in the gasket pipe.

25. The method of claim 22, wherein said providing a vacuum reservoir comprises providing a vacuum reservoir having a substantially larger volume than the vacuum lifting chamber.
